(19) United States
(12) Patent Application Publication
(10) Pub. No.: US 2018/0183943 A1
(43) Pub. Date: Jun. 28, 2018

(54) IMAGE FORMING DEVICE AND IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Akihiro MORO, Sunto Shizuoka (JP)

(21) Appl. No.: 15/391,612

(22) Filed: Dec. 27, 2016

(51) Int. Cl. H04N 1/00; H04N 1/333

(52) U.S. Cl. CPC H04N 1/00082; H04N 1/00015; H04N 1/00037; H04N 2201/3256; H04N 2201/0094; H04N 2201/3243; H04N 2201/3245; H04N 1/333

(57) ABSTRACT

An image forming device includes a first image forming unit, a second image forming unit, and a control unit. The first image forming unit is configured to form an image on a medium using a decolorable material. The second image forming unit is configured to form an image on a medium using a non-decolorable material. The control unit is configured to detect one or more user-designated regions in image data of an original document, and control one of the first image forming unit and the second image forming unit to form on a medium an image of the image data inside of the user-designated regions and the other of the first image forming unit and the second image forming unit to form on the medium an image of the image data outside the user-designated regions.

### FIELD

Embodiments described herein relate generally to an image forming device and an image forming method.

### BACKGROUND

Nowadays, if a company or a government agency requests a customer to fill out a form, the form has supplementary information, so that the customer can accurately fill out the form. However, the supplementary information is often not needed after the form is completed.

### BRIEF DESCRIPTION OF THE DRAWINGS

FIG. 1 is an external view of an image forming device according to an embodiment.

FIG. 2 is a diagram illustrating a specific example of an internal configuration of the image forming device according to the embodiment.

FIG. 3 is a block diagram illustrating communication flows during image formation processing between components of the image forming device according to the embodiment.

FIG. 4 is a block diagram illustrating a functional configuration of an image formation processing unit, an image processing unit, and a system control unit according to the embodiment.

FIG. 5 is a diagram illustrating a specific example of a read target which is processed in the embodiment and is surrounded by a closed shape drawn by a marker pen.

FIG. 6 is a diagram illustrating a specific example of a read target that is copied in a mixed print reproduction mode according to the embodiment.

FIG. 7 is a diagram illustrating a specific example of a read target that is decolored by decoloring erasure reproduction processing.

FIG. 8 is a diagram illustrating a specific example of selecting a designated region using a control panel in the embodiment.

FIG. 9 and FIG. 10 depict a flowchart illustrating a flow of processing of the image forming device according to the embodiment.

### DETAILED DESCRIPTION

According to one embodiment, an image forming device includes a first image forming unit, a second image forming unit, and a control unit. The first image forming unit forms an image on a medium using a decolorable material. The second image forming unit forms an image on an a medium using a non-decolorable material. The control unit is configured to detect one or more user-designated regions in image data of an original document, and control one of the first image forming unit and the second image forming unit to form on a medium an image of the image data inside of the user-designated regions and the other of the first image forming unit and the second image forming unit to form on the medium an image of the image data outside the user-designated regions.

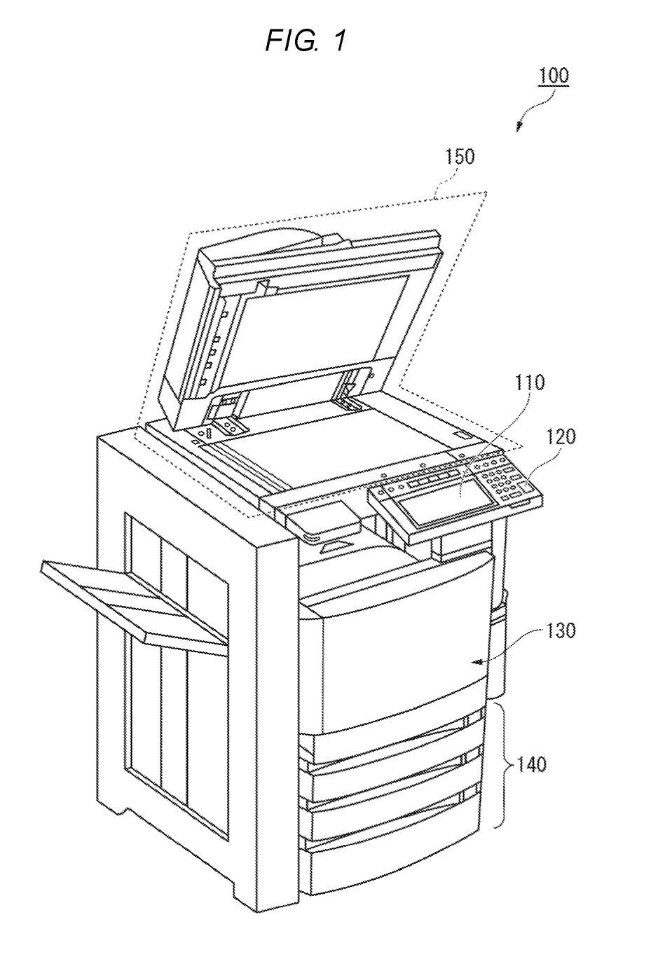

Hereinafter, an image forming device 100 according to the embodiment will be described with reference to the drawings. FIG. 1 is an external view illustrating an entire configuration example of the image forming device 100 according to the embodiment. The image forming device 100 is an image forming device such as a multi-function peripheral (MFP). The image forming device 100 includes a display 110, a control panel 120, an image formation processing unit 130, an image forming medium containing unit 140, and an image reading unit 150. The image formation processing unit 130 of the image forming device 100 fixes a toner image.

The image forming device 100 forms an image on an image forming medium, using a developing agent such as toner. Toner may be non-decolorable toner which cannot be decolored, and decolorable toner which can be decolored after an image is formed. Known decolorable toner or non-decolorable toner, which is disclosed in U.S. Pat. No. 9,134,668, can be used for the toner. The image forming medium is, for example, paper or label paper.

The image forming device 100 according to the embodiment forms an image at any one image output mode which is selected from a decolorable print reproduction mode, a normal print reproduction mode, and a mixed print reproduction mode. The image forming medium forms the entire image using decolorable toner in the decolorable print reproduction mode. The image forming medium forms the entire image using non-decolorable toner in the normal print reproduction mode. The image forming medium forms an image inside a designated region of a page using the decolorable toner and outside the designated region using the non-decolorable toner in the mixed print reproduction mode. The designated region is a place where a user wants to form an image using the decolorable toner, in an image data which is read or received for printing. The toner which is used inside of the designated region is different from the toner which is used outside of the designated region. For example, an image is formed inside of the designated region using the decolorable toner, and an image formed outside of the designated region using the non-decolorable toner. If a decolorable erasure reproduction mode is selected, the image forming device 100 performs decolorable erasure reproduction processing. The image forming device 100 decolors a region where an image is formed by the decolorable erasure reproduction processing using the decolorable toner. Specifically, a user manually feeds or sets in a cassette (not illustrated) for decolorable the image forming medium in which an image is formed by using the decolorable toner. As the image forming device 100 performs the decolorable erasure reproduction processing, a region in which an image is formed by using decolorable toner is decolored.

The display 110 is an image display device such as a liquid crystal display or an electro luminescence (EL) display. The display 110 displays various information relating to the image forming device 100.

The control panel 120 includes a plurality of buttons. The control panel 120 receives operation of a user. The control panel 120 outputs a signal according to the operation which is performed by the user to a control unit of the image forming device 100. The display 110 and the control panel 120 may be integrated as one touch panel. The control panel 120 is an aspect of an operation panel.

The image formation processing unit 130 forms an image on the image forming medium, based on image data which is generated by the image reading unit 150 or image data which is received through a communication path. The image formation processing unit 130 forms an image according to, for example, the following processing. An image forming unit of the image formation processing unit 130 forms an electrostatic latent image on a photosensitive drum, based on the image data. The image forming unit of the image formation processing unit 130 forms a visible image by depositing a developing agent on the electrostatic latent image. The toner is a specific example of the developing agent. A transfer unit of the image formation processing unit 130 transfers a visible image onto the image forming medium. A fixing unit of the image formation processing unit 130 fixes the visible image on the image forming medium by heating and pressing the image forming medium. The decolorable toner is one example of a decolorable material. The non-decolorable toner is one example of a non-decolorable material.

The image forming medium containing unit 140 contains an image forming medium which is used for image formation of the image formation processing unit 130.

The image reading unit 150 reads image data of a read target by using brightness and darkness of light. The image reading unit 150 records the image data which is read. The image data which is recorded may be transmitted to other information processing devices through a network. An image corresponding to the image data which is recorded may be formed on the image forming medium by the image formation processing unit 130. The image data which is recorded may be displayed on the display 110.

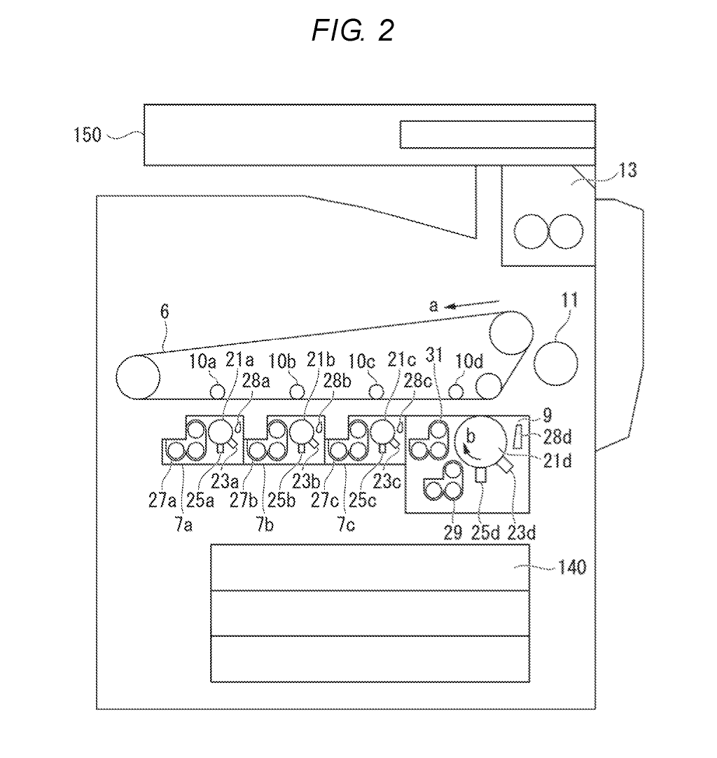

FIG. 2 is a diagram illustrating a specific example of an internal configuration of the image forming device 100 according to the embodiment. The image forming device 100 uses four tandem processes. A intermediate transfer belt 6 which can move in the direction of arrow a that is illustrated, and four image forming units 7a, 7b, 7c, and 9 which are arranged near the intermediate transfer belt are provided between the image reading unit 150 and the image forming medium containing unit 140. The image forming units 7a, 7b, and 7c are collectively referred to as a first image forming unit, and the image forming unit 9 is referred to as a second image forming unit. The image forming units 7a, 7b, and 7c form an image by respectively using yellow toner, magenta toner, and cyan toner which has non-decolorable properties. In addition, the image forming unit 9 forms an image by using either black toner with non-decolorable properties or blue toner with decolorable properties. The intermediate transfer belt 6 is interposed between the image forming units 7a, 7b, 7c, and 9 and transfer rollers 10a, 10b, 10c, and 10d which face each other. A second transfer roller 11 which transfers a toner image that is formed on the intermediate transfer belt 6 by the image forming units 7a, 7b, 7c, and 9 onto paper that is fed from the image forming medium containing unit 140, is arranged on the downstream side of the image forming unit 9 in a movement direction of the intermediate transfer belt 6. A fixing device 13 which fixes the toner image to the paper is arranged under the second transfer roller 11 along a travel direction of the paper which is fed from the image forming medium containing unit 140. Configurations of the image forming units 7a, 7b, and 7c are the same as each other except for the toner which is contained in the inside thereof. Accordingly, the configurations of the image forming units 7a, 7b, and 7c will be described by using the image forming unit 7a as an example.

The image forming unit 7a includes a photosensitive drum 21a. A charging unit 23a which charges the photosensitive drum 21a, an exposure device 25a of an LED type which exposes the charged photosensitive drum 21a according to image data, and a developing machine 27a which contains yellow toner with non-decolorable properties and develops an electrostatic latent image that is formed by the exposure device 25a are arranged around the photosensitive drum 21a. Furthermore, the image forming unit 7a includes a cleaning device 28a which removes remaining toner on the photosensitive drum 21a after a toner image on the photosensitive drum 21a is transferred by the transfer roller 10a.

In the same manner, the image forming unit 7b and 7c respectively include photosensitive drums 21b and 21c, charging units 23b and 23c, exposure devices 25b and 25c, developing machines 27b and 27c, and cleaning devices 28b and 28c. However, toner contained in the developing machine 27b is magenta toner with non-decolorable properties, and toner contained in the developing machine 27c is cyan toner with non-decolorable properties.

The image forming unit 9 includes a photosensitive drum 21d. The photosensitive drum 21d rotates in a direction of an arrow b which is illustrated. A charging unit 23d which charges the photosensitive drum 21d, and an exposure device 25d of an LED type which exposes the charged photosensitive drum 21d according to image data are arranged near the photosensitive drum 21d. In addition, a developing machine 29 and a developing machine 31 are arranged to face the photosensitive drum 21d in a rotation direction of the photosensitive drum 21d on the downstream side of the exposure device 25d. The developing machine 29 contains blue toner with decolorable properties, and the developing machine 31 contains black toner with non-decolorable properties. In addition, the developing machine 29 and the developing machine 31 are selectively used for the photosensitive drum 21d, and developing is performed by either one of the developing machines. In addition, the image forming unit 9 includes a cleaning device 28d which removes toner on the photosensitive drum 21d after a toner image formed by the developing machine 29 or the developing machine 31, is transferred onto the intermediate transfer belt 6 by the transfer rollers 10d.

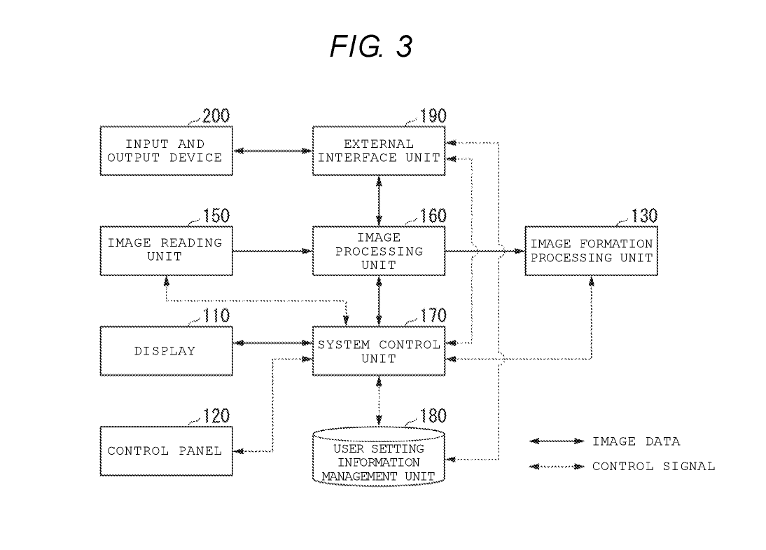

FIG. 3 is a block diagram illustrating a communication flows during image formation processing between components of the image forming device 100 according to the embodiment. The image forming device 100 includes the display 110, the control panel 120, the image formation processing unit 130, the image reading unit 150, an image processing unit 160, a system control unit 170, a user setting information management unit 180, an external interface unit 190, and an input and output device 200.

The image processing unit 160 is an image processor that sets parameter information for reading image data in advance according to control of the system control unit 170, and performs image processing according to each processing. The parameter information is used for forming an image with a high image quality using the read image data. The parameter information is set for each non-decolorable toner or each decolorable toner. For example, the parameter information is set data which is processed by resolution and gradation processing so as to provide image quality suitable for each toner which is used. In the image data, a region in which non-decolorable toner is used is referred to as a non-decolorable data region. In the image data, a region in which decolorable toner is used is referred to as a decolorable data region.

The system control unit 170 transmits and receives a control signal, thereby, controlling operations of each unit of the image forming device 100. The system control unit 170 includes a device including, for example, a central processing unit (CPU) and a random access memory (RAM).

The user setting information management unit 180 includes a storage device such as a magnetic hard disk device or a semiconductor memory device. The user setting information management unit 180 stores a designated region which is selected from the read image data by a user. The user setting information management unit 180 may include a RAM.

The external interface unit 190 communicates with the input and output device 200. The external interface unit 190 transmits image data which is read by the image reading unit 150 to the input and output device 200. The external interface unit 190 receives image data from the input and output device 200. The external interface unit 190 is, for example, a network connector.

The input and output device 200 communicates with the image forming device 100. The input and output device 200 is an information processing device such as a personal computer or a smartphone. The input and output device 200 is one example of an external input and output device.

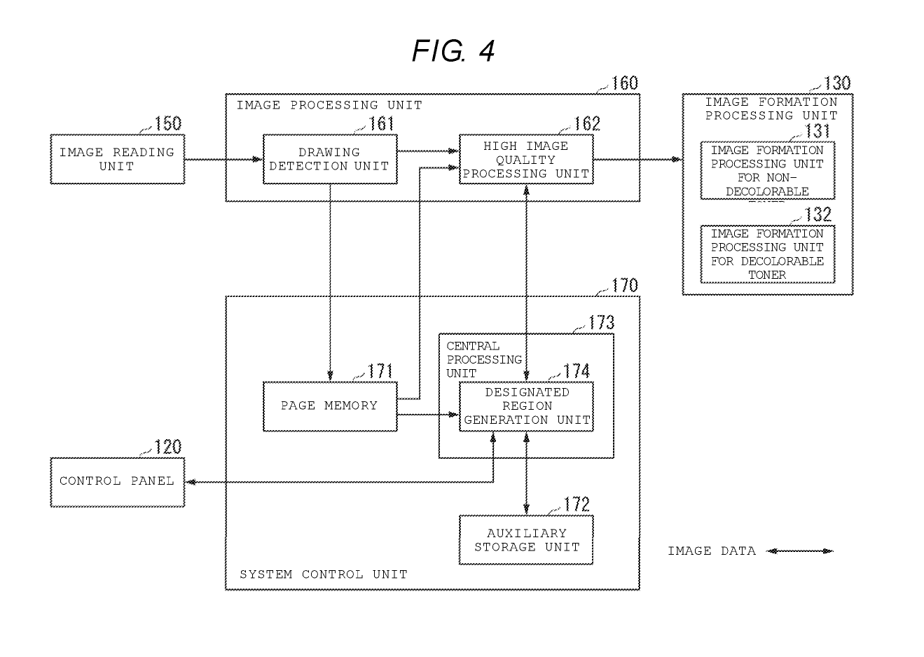

FIG. 4 is a block diagram illustrating a functional configuration of the image formation processing unit 130, the image processing unit 160, and the system control unit 170 according to the embodiment. The image formation processing unit 130 includes an image formation processing unit 131 for non-decolorable toner and an image formation processing unit 132 for decolorable toner. The image processing unit 160 includes a drawing detection unit 161 and a high image quality processing unit 162. The system control unit 170 includes a page memory 171, an auxiliary storage unit 172, and a central processing unit 173.

The image formation processing unit 131 for non-decolorable toner forms a predetermined region of image data as an image, using the non-decolorable toner. In the present embodiment, a region in which an image is formed by the image formation processing unit 131 for non-decolorable toner is a region other than the designated region. The image formation processing unit 131 for non-decolorable toner is one example of the second image forming unit.

The image formation processing unit 132 for decolorable toner forms a predetermined region of the image data as an image, using the decolorable toner. In the present embodiment, a region in which an image is formed by the image formation processing unit 132 for decolorable toner is within the designated region. The image formation processing unit 132 for decolorable toner is one example of the first image forming unit.

The drawing detection unit 161 detects a region in which drawing is performed by using a writing instrument from the read image data. The writing instrument is, for example, a marker pen. A user designates a region that the user wants to erase by using a color of a marker pen or the like which can be detected. In the present embodiment, the drawing detection unit 161 determines that the inside of a region surrounded by a circle drawn by the marker pen is the inside of the designated region, and determines that the outside of the region surrounded by a circle drawn by the marker pen is the outside of the designated region. The image formation processing unit 130 forms an image by using decolorable toner in the inside of the designated region, and forms an image by using non-decolorable toner in the outside of the designated region.

The high image quality processing unit 162 sets the parameter information in inside and outside each of the designated regions of the image data, and performs high image quality processing suitable for each designated region. The high image quality processing unit 162 generates image data with high image quality by performing each processing, based on parameter information suitable for a non-decolorable data region in which non-decolorable toner is used and a decolorable data region in which decolorable toner is used, using, for example, sharpness and γ correction. The high image quality processing unit 162 outputs the image data to which processing suitable for each designated region is performed to the image formation processing unit 130 according to the designated region. The high image quality processing unit 162 is one example of the image formation processing unit.

The page memory 171 includes a volatile memory device such as a RAM. The page memory 171 temporarily stores the read image data and data that a central processing unit 173 is processing. For example, the page memory 171 registers program data that the central processing unit 173 executes.

The auxiliary storage unit 172 includes a storage device such as a magnetic hard disk device or a semiconductor memory device. The auxiliary storage unit 172 stores a control program that the central processing unit 173 uses to control each function, control data, and various data. The auxiliary storage unit 172 stores, for example, an image read processing program of the image forming device 100.

The central processing unit 173 includes a processing device such as a CPU. The central processing unit 173 controls the functional units of the image forming device 100. The central processing unit 173 functions as a designated region generation unit 174 by executing, for example, a designated region generation program, the algorithm for which is described below.

The designated region generation unit 174 generates designated region data from a region detected by the drawing detection unit 161. The designated region data has information for identifying the inside of the designated region and the outside of the designated region in the image data. In addition, the designated region generation unit 174 generates designated region data by using a region designated by a user through the control panel 120.

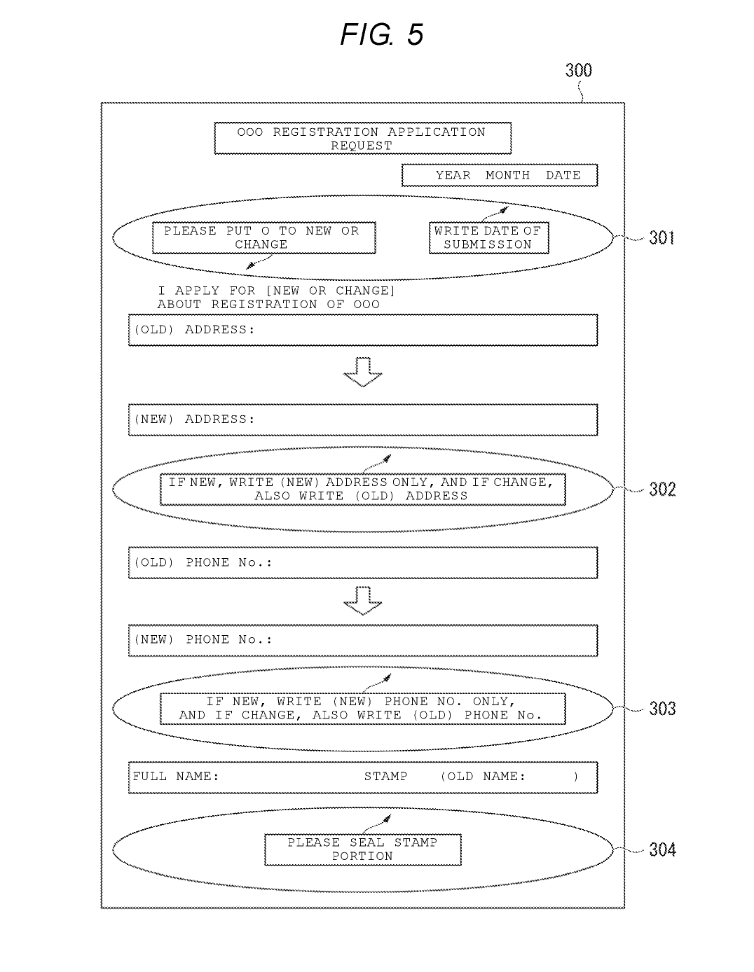

FIG. 5 is a diagram illustrating a specific example of a read target which is processed in the embodiment and is surrounded by a circle drawn by a marker pen. 300 in FIG. 5 denotes entirety of the read target. 300 in FIG. 5 includes 301 in FIG. 5, 302 in FIG. 5, 303 in FIG. 5, and 304 in FIG. 5 which are regions surrounded by a circle that a user draws by using the marker pen. When copying 300 in FIG. 5, the user selects the mixed print reproduction mode through the control panel 120. In this case, an image is formed by the decolorable toner inside of 301 in FIG. 5, 302 in FIG. 5, 303 in FIG. 5, and 304 in FIG. 5 which are regions surrounded by circles drawn by the marker pen, and an image is formed by non-decolorable toner in other regions. Although shown in FIG. 5 for illustrative purposes, an image is not formed in frame borders of 301 in FIG. 5, 302 in FIG. 5, 303 in FIG. 5, and 304 in FIG. 5.

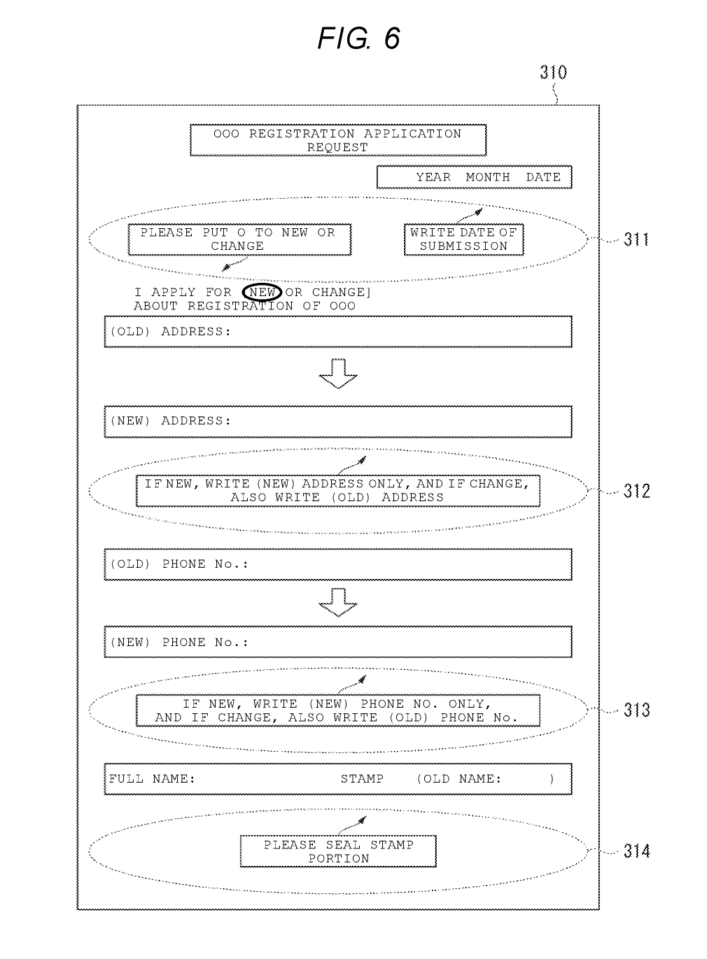

FIG. 6 is a diagram illustrating a specific example of a read target that is copied in the mixed print reproduction mode according to the embodiment. 310 in FIG. 6 denotes entirety of the copied read target. 310 in FIG. 6 includes 311 in FIG. 6, 312 in FIG. 6, 313 in FIG. 6, and 314 in FIG. 6 in which images are formed by decolorable toner. If the image forming device 100 performs decolorable erasure reproduction processing for 310 in FIG. 6, the insides of 311 in FIG. 6, 312 in FIG. 6, 313 in FIG. 6, and 314 in FIG. 6 which are regions where images are formed by the decolorable toner are decolored. Although shown in FIG. 6 for illustrative purposes, an image is not formed in frame borders of 311 in FIG. 6, 312 in FIG. 6, 313 in FIG. 6, and 314 in FIG. 6.

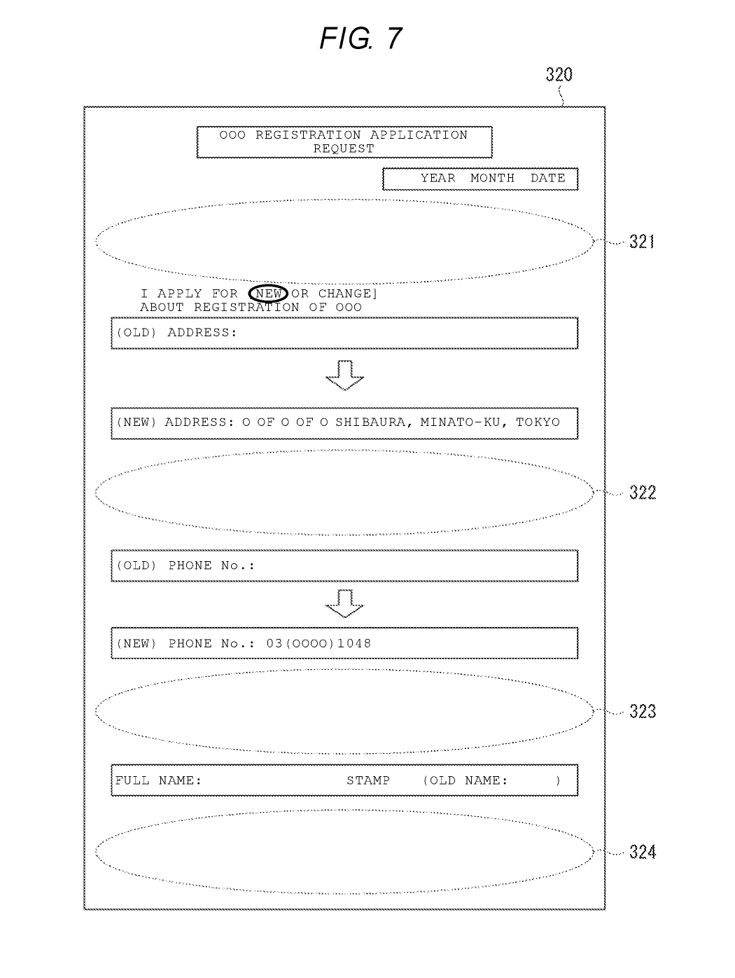

FIG. 7 is a diagram illustrating a specific example of a read target decolored by the decoloring erasure reproduction processing. 320 in FIG. 7 denotes entirety of the decolored read target. 320 in FIG. 7 includes 321 in FIG. 7, 322 in FIG. 7, 323 in FIG. 7, and 324 in FIG. 7 which are decolored. Although shown in FIG. 7 for illustrative purposes, an image is not formed in frame borders of 321 in FIG. 7, 322 in FIG. 7, 323 in FIG. 7, and 324 in FIG. 7.

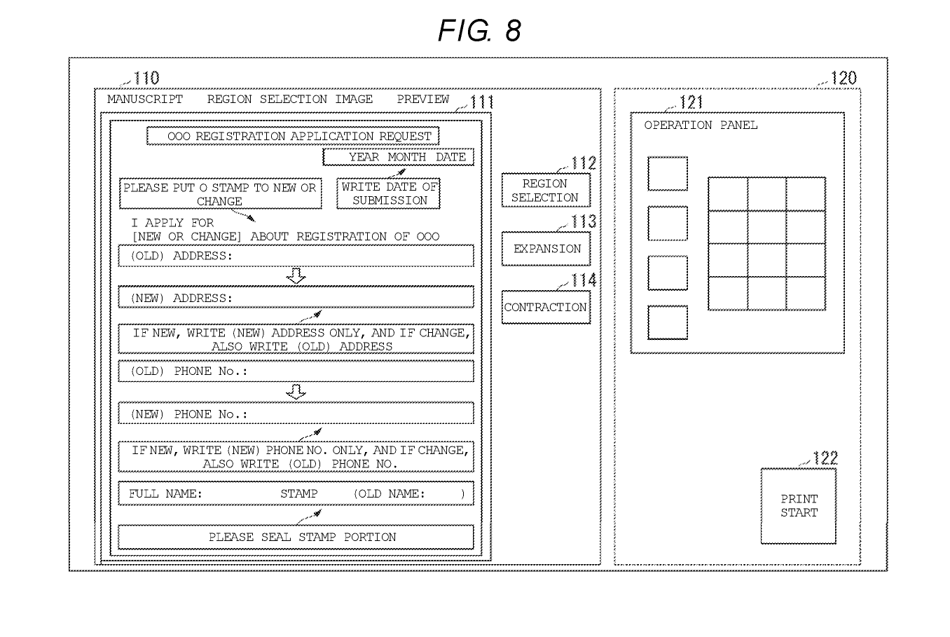

FIG. 8 is a diagram illustrating a specific example of selecting a designated region using the control panel in the embodiment. The display 110 displays a designated region selection image display unit 111 in FIG. 8, a region selection button 112 in FIG. 8, an expansion button 113 in FIG. 8, and a contraction button 114 in FIG. 8. The control panel 120 includes an operation panel 121 in FIG. 8 and a print start button 122 in FIG. 8.

A thumbnail image of the read image data is displayed on the designated region selection image display unit 111. The region selection button 112 to the contraction button 114 can be operated by a user. The user operates the operation panel 121 and selects the region selection button 112 to the contraction button 114. For example, if the user selects the region selection button 112, an arbitrary region can be selected from the thumbnail image. A specific region of the thumbnail image is selected as the user operates the operation panel 121. For example, if the user selects the expansion button 113, a predetermined place of the thumbnail image is expanded to be displayed. The predetermined place of the thumbnail image is selected as the user operates the operation panel 121. For example, if the user selects the contraction button 114, a predetermined place of the thumbnail image is contracted to be displayed. The predetermined place of the thumbnail image may be selected as the user operates the operation panel 121. In addition, the user can also select an arbitrary region by performing click designation of a diagonal region on the thumbnail image of the designated region selection image display unit 111 using a finger or the like. After the region is selected, the user selects the print start button 122 in FIG. 8, whereby printing can be performed. At this time, the inside of the region which is selected in the thumbnail image becomes the inside of the designated region, and is printed by using the decolorable toner. The embodiment illustrated in FIG. 8 is just one specific example. Accordingly, the embodiment may include examples different from that in FIG. 8.

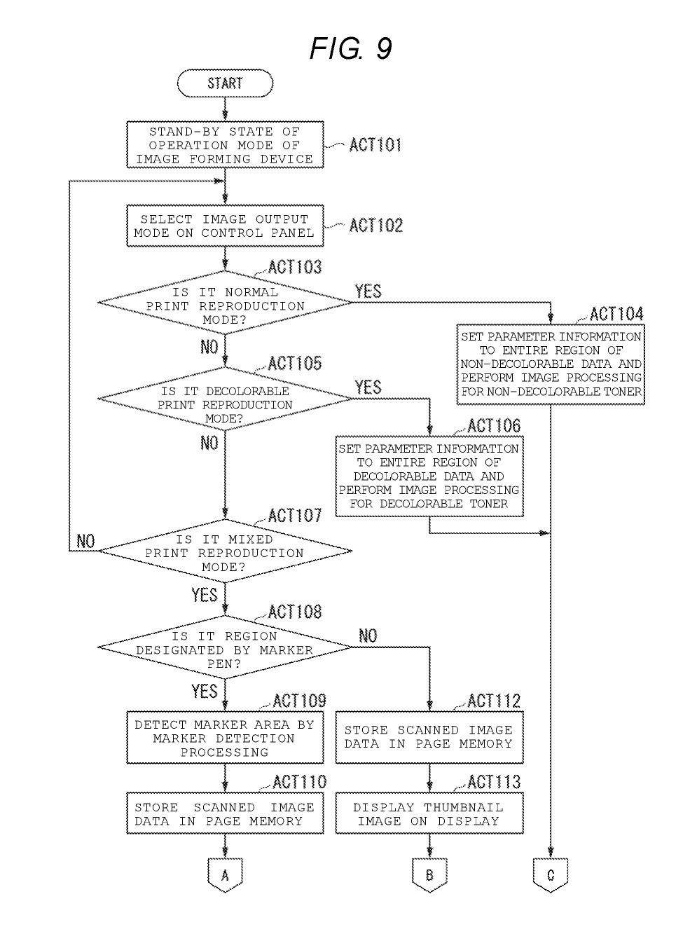

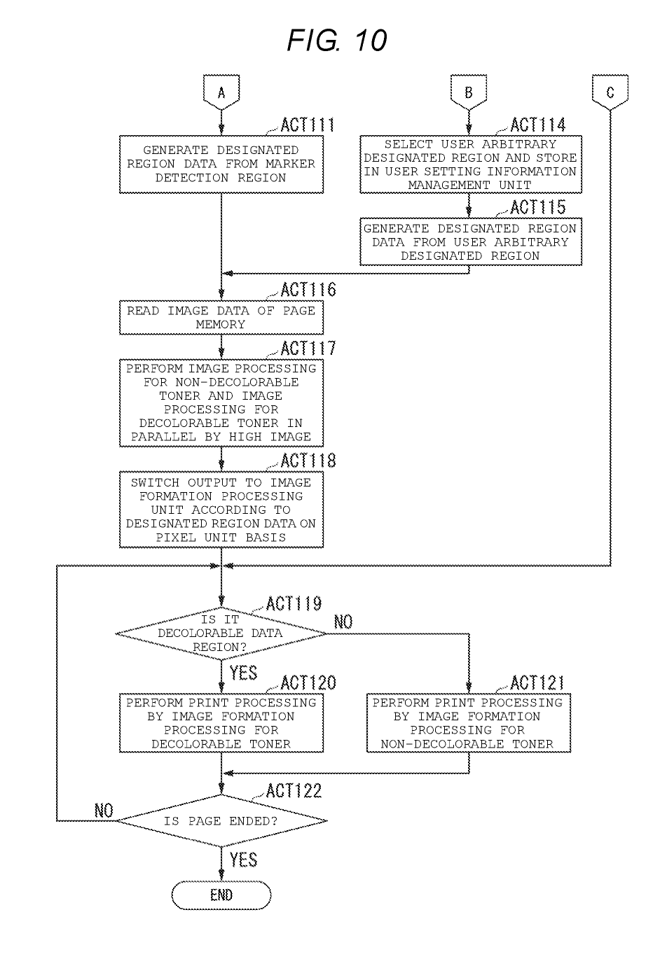

FIG. 9 and FIG. 10 are flowcharts illustrating a flow of processing of the image forming device 100 according to the embodiment. The image forming device 100 operates in a standby state (ACT101). The control panel 120 of the image forming device 100 receives an image output mode from a user (ACT102). The system control unit 170 determines whether or not the received image output mode is a normal print reproduction mode (ACT103). If the normal print reproduction mode is selected (ACT103: YES), the image processing unit 160 sets the parameter information and performs image processing such that the entire region of the read image data becomes a non-decolorable data region in which an image is formed by non-decolorable toner (ACT104). If the normal print reproduction mode is not selected (ACT103: NO), the system control unit 170 determines whether or not the received image output mode is a decolorable print reproduction mode (ACT105). If the decolorable print reproduction mode is selected (ACT105: YES), the image processing unit 160 sets the parameter information and performs the image processing such that the entire region of the read image data becomes a decolorable data region in which an image is formed by decolorable toner (ACT106). If the decolorable print reproduction mode is not selected (ACT105: NO), the system control unit 170 determines whether or not the received image output mode is a mixed print reproduction mode (ACT107). If the mixed print reproduction mode is not selected (ACT107: NO), the processing returns to ACT102. If the mixed print reproduction mode is selected (ACT107: YES), the system control unit 170 of the image forming device 100 determines whether or not the control panel 120 receives a region which is designated by a marker pen (ACT108). If there is the region which is designated by the marker pen (ACT108: YES), the drawing detection unit 161 detects the designated region surrounded by a circle drawn by the marker pen (ACT109). The drawing detection unit 161 stores the read image data in the page memory 171 (ACT110). The designated region generation unit 174 generates designated region data of a pixel unit in a page from the designated region surrounded by the circle drawn by the marker pen (ACT111). Meanwhile, if the designated region surrounded by the circle drawn by the marker pen is not selected (ACT108: NO), the drawing detection unit 161 stores the read image data in the page memory 171 (ACT112). The display 110 displays a thumbnail image of the read image data (ACT113). The user selects an arbitrary region to set the designated region by operating the control panel 120. The designated region is stored in the user setting information management unit 180 (ACT114). The designated region generation unit 174 generates the designated region data of a pixel unit in a page from the selected designated region (ACT115).

The high image quality processing unit 162 reads the image data from the page memory 171 (ACT116).

The high image quality processing unit 162 performs image processing according to each processing based on the parameter information for each region inside and outside of the designated region of the image data, based on the generated designated region data. The high image quality processing unit 162 generates image data with high image quality by performing each processing, based on the parameter information for the non-decolorable data region in which the non-decolorable toner is used and the decolorable data region in which the decolorable toner is used, using, for example, sharpness and γ correction (ACT117). The image processing unit 160 outputs the image data after the image formation processing unit 130 performs the image processing according to the designated region data which is designated on a pixel unit basis (ACT118). It is determined whether or not the image data which is output is in the decolorable data region (ACT119). If the image data which is output is in the decolorable data region (ACT119: YES), the image formation processing unit 132 for decolorable toner performs image formation processing based on the image data (ACT120). If the image data which is output is not in the decolorable data region (ACT119: NO), the image formation processing unit 131 for non-decolorable toner performs the image formation processing based on the image data (ACT121). Subsequently, the system control unit 170 determines whether or not the page ends (ACT122). If the page ends (ACT122: YES), the image forming device 100 ends the processing. If the page does not end (ACT122: NO), the image forming device 100 returns to the processing of ACT119.

As the user draws a circle surrounding unnecessary information using the marker pen, the image forming device 100 having the aforementioned configuration can form an image in the inside of the surrounded region using the decolorable toner. Accordingly, the surrounded region can be decolored after the image is formed, and thus, it is possible to prevent easiness in viewing the document from being impaired due to existence of unnecessary information.

When receiving the image data from the input and output device 200, the image forming device 100 may receive the designated region. By configuring in this way, a user does not need to select the designated region from the control panel 120 after the user transmits the image data from the input and output device 200. Accordingly, convenience of the user is increased.

The image forming device 100 may receive the designated region from the user through the control panel 120 after the drawing detection unit 161 detects the drawn region. With this configure, a region can be added even in a case where a portion to be drawn by the user is left out.

The image forming device 100 according to the present embodiment may provide a configuration such that an image of the inside of the designated region is formed by using non-decolorable toner and an image of the outside of the designated region is formed by using decolorable toner. With this configuration, the user can select a region that he wants to save from an image of a read target.

The drawing detection unit 161 may determine that the inside of a region which is colored by a writing instrument as the inside of the designated region, and may determine that the outside of the region which is colored by the writing instrument as the outside of the designated region.

The image forming device 100 according to the present embodiment describes that a marker pen is used as the writing instrument, but may include other writing instruments such as a ballpoint pen. The image forming device 100 according to the present embodiment describes that toner is used as developing agency, but may include other developing agency such as ink.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image forming device comprising:
a first image forming unit configured to form an image on a medium using a decolorable material;
a second image forming unit configured to form an image on a medium using a non-decolorable material; and
a control unit having a processor and a memory, and configured to detect one or more user-designated regions in image data of an original document, and control the first image forming unit and the second image forming unit to form on a medium an image of the image data inside the user-designated regions using the decolorable material and not the non-decolorable material, and to form on the medium an image of the image data outside the user-designated regions using the non-decolorable material and not the decolorable material.

2. The device according to claim 1, further comprising:
an image processor configured to process the image data to detect a closed shape drawn by a writing instrument and determine the area enclosed by the closed shape to be a user-designated region.

3. The device according to claim 2, further comprising:
an operation panel configured to receive inputs from a user,
wherein, responsive to a user input made through the operation panel indicating that the designated region is designated from the image data, the control unit controls the first image forming unit and the second image forming unit to form the images.

4. The device according to claim 1, further comprising:
an image processor configured to process the image data to detect a region colored by a writing instrument and determine the colored region to be a user-designated region.

5. The device according to claim 4, further comprising:
an operation panel configured to receive inputs from a user,
wherein, responsive to a user input made through the operation panel indicating that the designated region is designated from the image data, the control unit controls the first image forming unit and the second image forming unit to form the images.

6. The device according to claim 1, further comprising:
an operation panel configured to receive inputs from a user,
wherein the control unit, responsive to user inputs made through the operation panel, expands or contracts a region of the image data displayed on a display unit as a user-designated region, and determines the expanded or contracted region as the user-designated region.

7. The device according to claim 6,
wherein, responsive to a user input made through the operation panel indicating that the user-designated region is cancelled, the cancelled user-designated region is no longer displayed as the user-designated region on the display unit.

8. The device according to claim 1, further comprising:
an external interface unit through which the image forming device communicates with an external device,
wherein the image forming device receives the image data and information indicating the user-designated regions from the external device.

9. (canceled)

10. (canceled)

11. An image forming method carried out in an image forming device that includes a first image forming unit and a second image forming unit, said method comprising:
detecting by a processor of the image forming device, one or more user-designated regions in image data of an original document;
performing a first image formation inside the user-designated regions only with the first image forming unit to form an image on a medium using a decolorable material; and
performing a second image formation outside the user-designated regions only with the second image forming unit an image on the medium using a non-decolorable material.

12. The method according to claim 11, further comprising:
processing the image data to detect a closed shape drawn by a writing instrument; and
determining the area enclosed by the closed shape to be a user-designated region.

13. The method according to claim 12, further comprising:
receiving inputs from a user through an operation panel,
wherein the first image formation and the second image formation are performed responsive to a user input made through the operation panel indicating that the designated region is designated from the image data.

14. The method according to claim 11, further comprising:
processing the image data to detect a region colored by a writing instrument; and
determining the colored region to be a user-designated region.

15. The method according to claim 14, further comprising:
receiving inputs from a user through an operation panel,
wherein the first image formation and the second image formation are performed responsive to a user input made through the operation panel indicating that the designated region is designated from the image data.

16. The method according to claim 11, further comprising:
displaying the image data on a display unit along with indications of the user-designated regions; and
receiving inputs from a user through an operation panel,
wherein, responsive to user inputs made through the operation panel, a region of the image data displayed on a display unit expands or contracts, and the expanded or contracted region is determined as a user-designated region.

17. The method according to claim 16,
wherein, responsive to a user input made through the operation panel indicating that a user-designated region is cancelled, the cancelled region is no longer indicated as the user-designated region on the display unit.

18. The method according to claim 11, further comprising:
receiving the image from an external device through an external interface unit.

19. The method according to claim 18,
wherein the external device transmits information indicating the user-designated regions along with the image data.

20. (canceled)

21. An image forming device comprising:
a first image forming unit configured to form an image on a medium using a decolorable material;
a second image forming unit configured to form an image on a medium using a non-decolorable material; and
a control unit having a processor and a memory, and configured to detect one or more user-designated regions in image data of an original document, and control the first image forming unit and the second image forming unit to form on a medium an image of the image data inside the user-designated regions using the non-decolorable material and not the decolorable material, and to form on the medium an image of the image data outside the user-designated regions using the decolorable material and not the non-decolorable material.

22. The device according to claim 21, further comprising:
an operation panel configured to receive inputs from a user,
wherein, responsive to a user input made through the operation panel indicating that the designated region is designated from the image data, the control unit controls the first image forming unit and the second image forming unit to form the images.

23. The device according to claim 21, further comprising:
an external interface unit through which the image forming device communicates with an external device,
wherein the image forming device receives the image data and information indicating the user-designated regions from the external device.
